(19) United States
(12) Patent Application Publication
(10) Pub. No.: US 2015/0147998 A1
(43) Pub. Date: May 28, 2015

(54) METHOD AND DEVICE FOR TRANSMITTING SOUND, IMAGE AND POSITION DATA TO A CONTROL CENTER IN THE EVENT OF AN EMERGENCY

(71) Applicant: Azhar N. Kamal, Muenchen (DE)

(72) Inventor: Azhar N. Kamal, Muenchen (DE)

(21) Appl. No.: 14/400,237

(22) PCT Filed: May 14, 2013
(86) PCT No.: PCT/DE2013/000262

§ 371 Date: Nov. 10, 2014

(30) Foreign Application Priority Data
May 14, 2012 (DE) 10 2012 009 498.1
Nov. 8, 2012 (DE) 10 2012 021 785.4

(51) Int. Cl. H04W 4/22; H04W 64/00; H04W 28/06; H04M 11/04

(52) U.S. Cl. CPC H04W 4/22; H04M 11/04; H04W 64/006; H04W 28/06; H04M 2242/04
USPC 455/404.2

(57) ABSTRACT

The invention relates to a method and device for transmitting sound, image and position data to a control centre (2) in the event of an emergency by means of a mobile telephone (1). The device is equipped with a camera (3), a microphone (4), a positioning device (6) for determining position data, a control device (7) having a memory (14) and software which is stored in the memory and which controls the recording and the transmission of image data, sound data and position data. After the software is accessed, image data is automatically recorded with the camera (3) and sound data is automatically recorded with the microphone (4), the position data of the mobile telephone (1) is determined, the image data and sound data is compressed, a connection to the control centre (2) is established, and the position data, the compressed image data and sound data is transmitted to the control centre (2).

The invention relates to a method and device for transmitting sound, image and position data to a control centre in the event of an emergency by means of a mobile telephone.

Mobile telephones provide the opportunity to call an emergency control centre in the event of an emergency, or to send texts or images by SMS or MMS to an emergency control centre with the aim of placing an emergency call. A disadvantage here is that in the event of an emergency it is usually necessary to act so swiftly that little time is available for finding the telephone number of an emergency control centre and taking the appropriate action step by step. In addition, in situations where certain persons pose a threat, it is difficult or impossible to place such an emergency call unnoticed without attracting the attention of the person who poses a threat.

The invention is therefore based on the task of providing a method and device for transmitting sound, image and/or position data to a control centre in the event of an emergency by placing an emergency call using a mobile telephone without the need to select a telephone number of a control centre and initiate the transmission of image, sound and/or position data individually, and without attracting the attention of third parties in the process.

This task is solved by a method according to claim 1 and by a device according to claim 10. To that end a mobile telephone is envisaged and equipped with a camera, a microphone, a positioning device for determining position data and software which controls the recording and the transmission of image, sound and position data. The sound data is also referred to as audio data and the image data also referred to as video data. The method is characterised in that a safety application is activated by accessing the software and that this automatically triggers the recording of image data by the camera, the recording of sound data by the microphone and the determination of the mobile telephone's position data by the position sensor. The image and sound data recorded is compressed losslessly. In addition, a connection to a control centre is established automatically. The compressed audio and video data as well as the position data is automatically transmitted to the control centre. The only action required by the user is to call up the software on his/her mobile telephone. All other steps take place automatically and without the need for further action. The control centre automatically matches the incoming image, sound and position data to an emergency call, and treats it as such. It is beneficial that the image data and position data is displayed on a display device in the control centre. The sound data is reproduced over a speaker. To that end it is beneficial that the control centre is equipped with a display device and a speaker. The incoming data at the control centre can be registered by one person. That person can get an impression of his/her own regarding the emergency on the basis of the image, sound and position data without needing a further conversation with the person who has placed the emergency call. The person placing the emergency call can thus avoid attracting attention; this is important particularly in situations where the emergency derives from a threatening situation.

The control centre may be an emergency call centre, control centre or operations centre running the operations of more than one organisation. These include public organisations such as the police, fire service, rescue services and technical relief agency. The control centre may moreover be a private organisation, for example belonging to a security company or a mobile emergency service. The control centre may also constitute a private individual acting as the contact person. For children, the control centre may be the landline or mobile telephone of the parents. In the method according to the invention, it is possible to send the image, sound and position data to more than one control centre simultaneously, for example to an emergency call centre and to a private individual acting as the contact person.

It is beneficial that the image data recorded comprises not just individual images, but image sequences and films with the accompanying sound data. In that way, the control centre can register not only the location of the occurrence, but also the time sequence of what is happening.

Compression of the image and sound data shortens the time required to transmit the data from the mobile telephone to the control centre. This is especially important in emergencies.

The image data and sound data recorded is compressed losslessly before it is transmitted to the control centre. This means that the image and sound data correspond exactly to the original data after decompression. This is important as the original data from the image and sound data recorded is to be available for subsequent evaluation of the emergency. With the help of this original data it may be possible to obtain information on the causes of the emergency, a perpetrator or witnesses.

It is beneficial that the position data is likewise compressed before it is transmitted, allowing the data to be transmitted quickly.

Transmission of the data can be terminated from the mobile telephone or in the control centre.

Carrying out the method is made possible by software that can be loaded into the memory of a programmable mobile telephone in the form of an application, known as an app. The method is started by activation of the software. It is beneficial that a start function is assigned to a button of the mobile telephone. If the software is loaded in a main memory of the mobile telephone, the recording and transmission of image, sound and position data can be started by pressing this button. Placing the emergency call is initiated by input of a single command. A mobile connection to a control centre is established automatically by the method. Image, sound and position data recorded by the mobile telephone is immediately transmitted to the control centre by the mobile connection. Special software recorded at the control centre can ensure that the data is displayed, stored and managed at the control centre.

It is beneficial that a hierarchy applies for the transmission of the data to the control centre. The position data is always transmitted to the control centre. If the mobile connection should not be good enough for compressed image data, compressed sound data and position data to be transmitted in a short period of time and to a good standard of quality, the control centre can at least identify from which mobile telephone and from what position an emergency call was placed. If the mobile connection is of good quality, the compressed image and sound data is also automatically transmitted in addition to the position data.

According to an advantageous embodiment of the invention, the mobile telephone records the time and transmits it to the control centre. The video, audio and position data can thus be recorded and stored in combination with a time and are correspondingly available for documentation purposes.

According to a further advantageous embodiment of the invention, the telephone number assigned to the mobile telephone is stored. In addition, further data for the mobile telephone or the person placing the emergency call can be stored, such as the IP address of the mobile telephone. This makes it possible subsequently to clearly match the data for the emergency stored in the control centre to a mobile telephone and therefore also to a person under whose name the mobile telephone is registered.

According to a further advantageous embodiment of the invention, the image data, sound data and position data is transmitted to the control centre in real time.

According to a further advantageous embodiment of the invention, the transmitted image data, sound data and position data is stored in a memory at the control centre. This ensures that it is documented accordingly. The documentation is available for subsequent investigations. The data remains available even if the mobile phone is damaged or destroyed in the emergency.

According to a further advantageous embodiment of the invention, the image, sound and position data is also stored at the mobile telephone provider. It can subsequently thus also be retrieved from there.

According to a further advantageous embodiment of the invention, the image data and sound data is decompressed after transmission to the control centre. The decompressed image data and sound data is then stored in a memory. This may be a memory at the control centre and/or a memory in the mobile telephone. In addition the data may also be stored in a memory of the mobile telephone provider.

According to a further advantageous embodiment of the invention, the position data is determined by means of the Global Positioning System GPS.

According to a further advantageous embodiment of the invention, the software is recorded in a memory of the mobile telephone in the form of an application.

According to a further advantageous embodiment of the invention, the data is transmitted from the control centre to the mobile telephone. This enables information to be forwarded from the control centre to the person placing the emergency call. The format of the data and the output of data via the mobile telephone to the person placing the emergency call depend on the nature of the emergency. The data may for example comprise voice or sound data that is output via a microphone on the mobile telephone. In addition, data in the form of text or image symbols can be transmitted and output on a monitor or a display device of the mobile phone. For input of the data at the control centre, it is beneficial that the control centre is equipped with suitable equipment such as a microphone or a keyboard. Furthermore, the control centre is preferably equipped with a transmitter device for transmitting the data to the mobile phone. Communication between the control centre and the person placing the emergency call is made possible in this way.

The device according to the invention for the transmission of sound, image and/or position data to a control centre is equipped with a programmable mobile telephone and a control centre. The mobile telephone features a camera, a microphone, a positioning device and a control device. The control device is equipped with a memory in which software is stored. Execution of the software, when accessed, automatically starts the recording of image and sound data and triggers the determination of position data, compresses the image and sound data, establishes a connection with a control centre and assures the transmission of data from the mobile telephone to the control centre. The control centre is equipped with a reception device to receive the data transmitted, as well as a display device.

It is beneficial that the control centre is equipped with a computer that is capable of receiving and processing the data transmitted by the mobile telephone. In particular the data can be stored in a memory of the computer and displayed on a display device of the computer. The computer furthermore features an input device via which the data can be input. The latter can be transmitted to the mobile telephone by contactless means via a mobile connection.

According to a further advantageous embodiment of the invention, the control centre is equipped with an alarm device which triggers an alarm when image data, sound data and position data is received from a mobile phone of the device.

According to a further advantageous embodiment of the invention, the control centre is equipped with an input device and with a transmission device, which transmits data to the mobile telephone.

According to a further advantageous embodiment of the invention, the control centre is equipped with a decompression device, which decompresses the compressed image and sound data.

The mobile telephone of the device according to the invention may be used by private individuals. In addition, it may be integrated into emergency vehicles or into public transport vehicles. It may also be permanently installed in areas accessible to the public. The device thus not only facilitates the placing of an emergency call to a control centre, but can also act as a deterrent to potential offenders. A subjective sense of safety may moreover be enhanced. In addition, storage of the data transmitted to a control centre facilitates the reconstruction of a progression of events at a later date.

Further advantages and advantageous embodiments of the invention can be obtained from the following description, the drawing and the claims.

### DRAWING

The drawing shows a model embodiment of the invention. Illustrations:

FIG. 1 Device for transmitting sound, image and position data to a control centre,

FIG. 2 Mobile telephone of the device according to FIG. 1 with casing open.

### DESCRIPTION OF THE MODEL EMBODIMENT

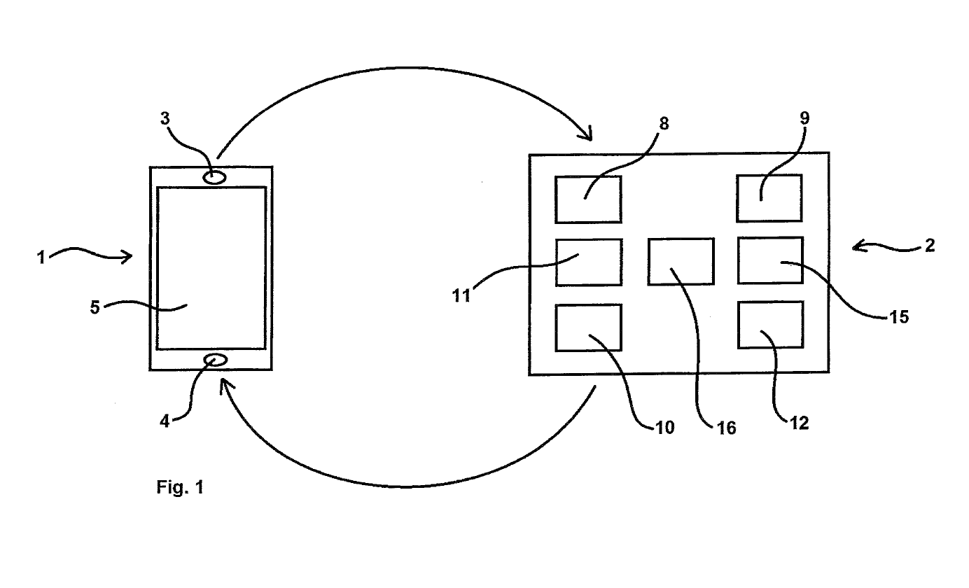

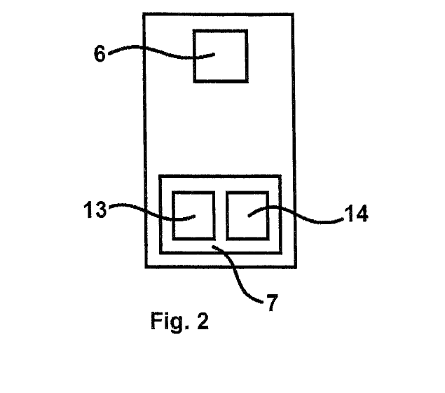

FIG. 1 shows a device for transmitting sound, image and position data with a mobile telephone 1 and a control centre 2. The mobile telephone features a camera 3, a microphone 4, a screen 5, a positioning device 6 and a control device 7. The control device 7 is equipped with a processor 13 and a memory 14. This is illustrated in FIG. 2. The control centre features a reception device 8, a display device 9, an alarm device 10, a memory device 11, a decompression device 12 and an input device 15.

In an emergency, a safety application is activated via the screen 5 having the form of a touchscreen of the mobile telephone 1 and the software for the application is accessed. The software is executed by the processor 13 of the mobile telephone 1. This prompts the microphone 4 to record sound data and the camera 3 to record image data. In addition, the position of the mobile telephone 1 is determined by means of the positioning device 6. The image data and the sound data is compressed by the processor 13 with the aid of a compression process. A mobile connection to the control centre 2 is established. The position data, the compressed image data and the compressed sound data is transmitted to the control centre 2 by the mobile telephone 1. The reception device 8 of the control centre 2 receives the position data, the image data and the sound data. The data received is displayed at the control centre on the display device 9. The control centre identifies from the incoming data that it relates to an emergency call. The alarm device 10 triggers an alarm at the control centre 2. The position, sound and image data is stored in the memory device 11. Before storage, the compressed image and sound data is decompressed with the decompression device 12. Data is input by means of the input device 15. This data is transmitted to the mobile telephone 1 by a transmission device 16. The data is for example displayed on the screen 5 of the mobile telephone.

All features of the invention can be material to the invention both individually and in any combination.

### REFERENCE NUMBERS

1 Mobile telephone
2 Control centre
3 Camera
4 Microphone
5 Screen
6 Positioning device
7 Control device
8 Reception device
9 Display device
10 Alarm device
11 Memory device
12 Decompression device
13 Processor
14 Memory
15 Input device
16 Transmission device

1. Method for transmitting sound, image and position data to a control center (2) in the event of an emergency by means of a mobile telephone (1), which is equipped with a camera (3), a microphone (4), a positioning device (6) for determining position data, a control device (7) having a memory (14) and software which is stored in the memory and which controls the recording and the transmission of image data, sound data and position data,
comprising the following process steps:
Accessing the software,
Recording image data with the camera (3),
Recording sound data with the microphone (4),
Determining the position data of the mobile telephone with the positioning device (6),
Lossless compression of the image data and the sound data,
Establishing a connection to the control center (2),
Transmitting the compressed image data and sound data as well as the position data to the control center (2),
where the recording of the image data and the sound data, the determination of the position data, the compression of the image data and the sound data, the establishing of a connection and the transmitting of the compressed image data, the compressed sound data and the position data are started automatically by the control device (7) equipped with the software when the software is accessed.

2. Method according to claim 1, wherein the time is recorded and transmitted to the control center (2).

3. Method according to claim 1, wherein the image data, sound data and position data is transmitted to the control center (2) in real time.

4. Method according to claim 1, wherein the transmitted image data, sound data and position data is stored in a memory device (11) at the control center (2).

5. Method according to claim 1, wherein the compressed image data and the compressed sound data is decompressed after transmission to the control center (2), and wherein the decompressed image data and the decompressed sound data is stored in a memory (14) or a memory device (11).

6. Method according to claim 1, wherein the position data is determined by means of GPS.

7. Method according to claim 1, wherein the software is recorded in a memory (14) of the mobile telephone (1) as an application.

8. Method according to claim 1, wherein data is transmitted from the control center (2) to the mobile telephone (1) and output by the mobile telephone (1).

9. Method according to claim 8, wherein the data comprises text, sound and/or images.

10. Device for transmitting sound, image and position data to a control center in the event of an emergency, for carrying out the method according to claim 1
with a programmable mobile telephone (1) with a camera (3), a microphone (4) and a positioning device (6),
with a control device (7) of the mobile telephone (1) exhibiting a processor (13) and a memory (14), in which memory (14) software is stored and which automatically starts the recording of image and sound data when accessed and triggers the determination of position data, compresses the recorded image data and sound data losslessly, establishes a connection to a control center (2), and transmits the position data as well as the compressed image data and sound data to the control center over this connection,
with a control center (2) that is equipped with a reception device (8) to receive the transmitted data and with a display device (9).

11. Device according to claim 10, wherein the control center (2) is equipped with an alarm device (10) which triggers an alarm upon receipt of image data, sound data and position data from a mobile telephone (1).

12. Device according to claim 10, wherein the control center (2) is equipped with a storage device (11) which stores the image data, sound data and position data transmitted by a mobile telephone (1) of the device.

13. Device according to claim 10, wherein the control center (2) is equipped with a decompression device (12) which decompresses the compressed image data and sound data losslessly.

14. Device according to claim 10, wherein the control center is equipped with an input device (15) and with a transmission device (16) which transmits data to the mobile telephone.
